(19) United States
(12) Patent Application Publication
(10) Pub. No.: US 2017/0219317 A1
(43) Pub. Date: Aug. 3, 2017

(54) COUNTER DRONE DEVICE, AND METHOD OF USING THE SAME

(71) Applicant: Stan William Sands, Atlanta, GA (US)

(72) Inventor: Stan William Sands, Atlanta, GA (US)

(21) Appl. No.: 15/259,170

(22) Filed: Sep. 8, 2016

Related U.S. Application Data
(60) Provisional application No. 62/288,804, filed on Jan. 29, 2016.

(51) Int. Cl. F41H 13/00; F42B 12/56

(52) U.S. Cl. CPC F41H 13/0006; F42B 12/56; B64C 39/024

(57) ABSTRACT

A counter drone device adapted to render propellers of drones inoperable. The counter drone device may be a weighted filament adapted to be projecting into the propeller of a drone so as to entangle/ensnare/wrap around propeller shaft and/or blades, rendering the drone inoperable.

### CROSS-REFERENCE TO RELATED APPLICATION

This application claims the benefit of priority of U.S. provisional application No. 62/288,804, filed Jan. 29, 2016, the contents of which are herein incorporated by reference.

### BACKGROUND OF THE INVENTION

The present invention relates to propeller inhibitors and, more particularly, a counter drone device adapted to render propellers of drones inoperable.

Drones are increasingly seen as effective potential weapon, not to mention a public nuisance when used by a private enthusiast to invade one's privacy, encroach on another's property rights or the like. Current counter drone measures to intercept and disable drones have flaws; for example, one counter approach against a remote control drone is to interfere or jam the controlling signal. It is, however, against FCC law to jam any signal, and so anyone seeking to disable a publicly used drone could face adverse legal and financial repercussions. Moreover, a programmable drone cannot be jammed. Another approach is to shoot down the drone with conventional weapons, but this is dangerous and impractical, especially in public.

As can be seen, there is a need for a counter drone device adapted to render propellers of drones inoperable, that is safe for innocent bystanders and legal, yet can cover a large area of intercept.

### SUMMARY OF THE INVENTION

In one aspect of the present invention, a counter drone device including an elongated filament extending between a first end and a second end, wherein the filament provides at least 6 pounds per square inch of tensile strength and a diameter consistent with braided line; and a first mass attached to the first end.

In another aspect of the present invention, the counter drone device includes an elongated foil extending between a first end and a second end, wherein the foil is made of malleable material, and wherein the foil tapers from the second end to the first end; and a first mass attached to the first end.

In yet another aspect of the present invention, a method of bringing down a drone in public without jam its controlling signal or using conventional weapons includes the steps of: providing counter drone specifications selected from the group consisting of a type of drone to be brought down, a size of the propellers the type of drone, and an altitude and a distance of an interception; determining a counter drone approach based in part on the counter drone specifications; determining the delivery mechanism based in part on the counter drone specifications; making a counter drone device based in part on the counter drone specifications, the counter drone device having an elongated filament extending between a first end and a second end, wherein the filament provides at least 6 pounds per square inch of tensile strength; and a first mass attached to the first end; and targeting the interception of the propellers and/or a propeller shaft of the type of drone by using the delivery mechanism.

These and other features, aspects and advantages of the present invention will become better understood with reference to the following drawings, description and claims.

### BRIEF DESCRIPTION OF THE DRAWINGS

FIG. 1 is an elevation view of an exemplary embodiment of the present invention;

FIG. 2 is an elevation view of an exemplary embodiment of the present invention, shown in use; and

FIG. 3 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a counter drone device adapted to render propellers of drones inoperable. The counter drone device may be a weighted filament adapted to be projecting into the propeller of a drone so as to entangle/ensnare/wrap around propeller shaft and/or blades, rendering the drone inoperable.

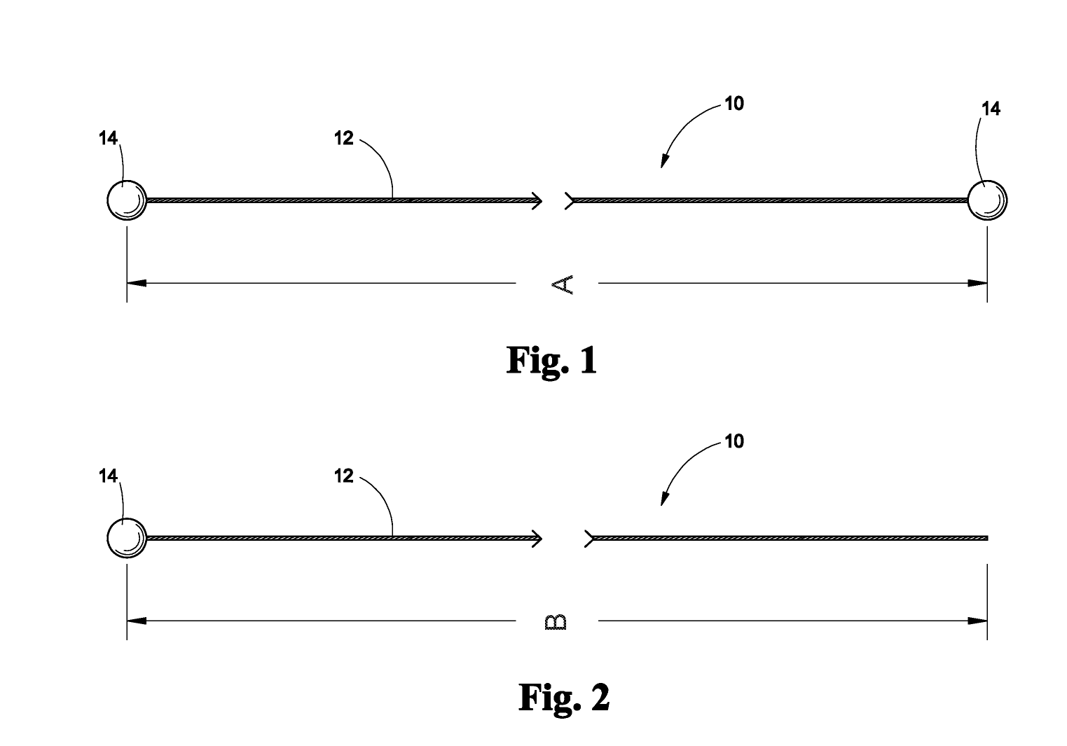

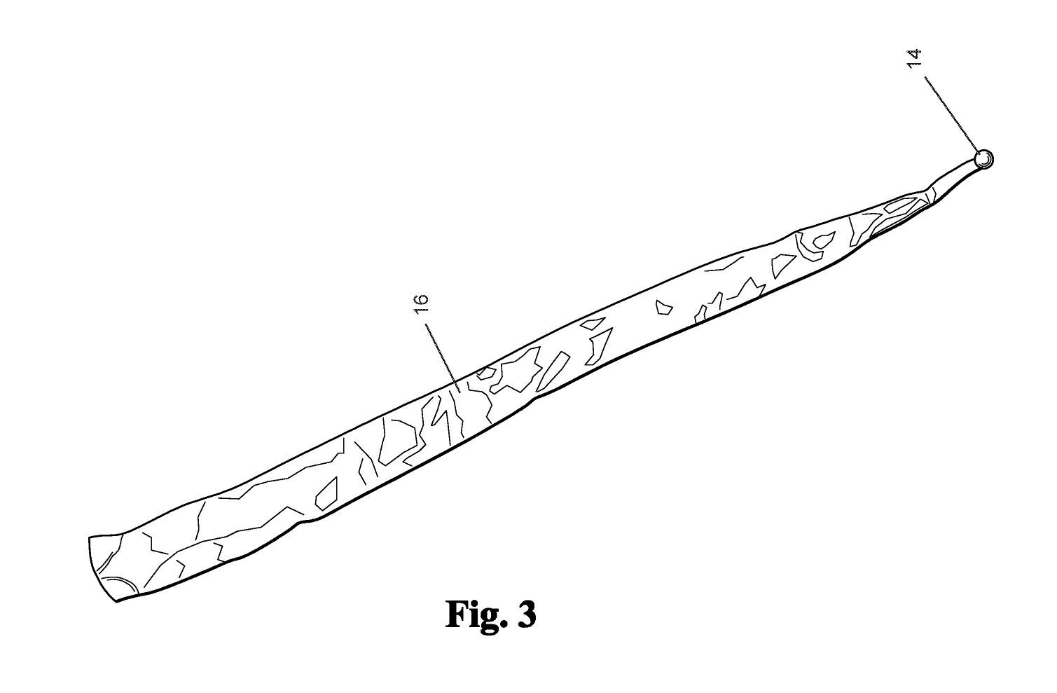

Referring now to FIGS. 1 through 3, the present invention may include a counter drone device 10 having a weighted filament 12. The filament 12 may be made of any elongated material that provides at least 6 pounds per square inch of tensile strength while providing a diameter consistent with braided line composed of Dacron, spectra, or micro-dyneema, for example nylon fishing line. The material may be adapted to prevent tangling of the filament 12 during use. The filament 12 may be various lengths, ranging from 10 inches to 10 feet, dimension ‘A’ or ‘B’, depending on the counter drone specifications needed for a predetermined counter drone approach. In other counter drone approaches, 18 inches up to 36 inches of filament 12 would be preferred. The counter drone specifications may include the type of drone to be rendered inoperable, the size of the propellers, the altitude and distance of interception, and the like.

The filament 12 will be weighted through providing a mass 14 at one or both ends of the filament 12, as illustrated in the Figures. The weight of the mass 14 is a function of the above mentioned counter drone specifications. In certain embodiments, the mass 14 may be a spherical projectile, such as a leaded bb, that is threaded on to the filament 12. In certain embodiments, the weight of the mass can vary from 0.47 g to 7.36 g.

In certain embodiments, the filament 12 may be replaced by a foil 16 that tapers down from a wider first end to an opposing end providing the mass 14. The foil 16 may be approximately 24 inches long, wherein the first end has a width about three times that of the opposing, mass end. The foil 16 may be a made of malleable material, such as metal, that lends itself to ensnaring and wrapping about the rotating propellers and propeller shaft upon contact.

The counter drone specifications also determine the delivery mechanism. In certain embodiments, the delivery mechanism may be an explosive mortar device, such as a fire work, or encapsulation in a paint-ball to be fire by a (paint ball) firearm. The counter drone device 10 may be distributed by paint ball firearm for low altitude interception, and mortar type devices for higher altitude and broader coverage.

The counter drone device 10 are dimensioned and adapted to interfere with flying parameters of a drone, so that once the counter drone device 10 comes in contact with propeller, it will entangle/ensnare/wrap around propeller shaft and/or propeller, rendering the drone inoperable.

A method of making the present invention may include the following. An individual may cut the length, dimension ‘A’ or ‘B’ of the filament 12 and weight the cut filament 12 with the mass(es) 14 in accordance with the counter drone specifications. In certain embodiments, a simple machine may thread the mass(es) 14 along the end(s) of the filament 12, and then wrap the counter drone device 10 in cylindrical pattern.

A method of using the present invention may include the following. The counter drone device 10 disclosed above may be provided. Based on the counter drone specifications, a user chooses the appropriate delivery mechanism, loads and fires the counter drone device 10.

Alternatively, the counter drone device 10 may be adapted for sporting venues, public assemblies, battle field applications, and for catching small flying animals.

It should be understood, of course, that the foregoing relates to exemplary embodiments of the invention and that modifications may be made without departing from the spirit and scope of the present invention.

What is claimed is:

1. A device, comprising:
an elongated filament extending between a first end and a second end, wherein the filament provides at least 6 pounds per square inch of tensile strength and a diameter consistent with braided line; and
a first mass attached to the first end.

2. The device of claim 1, further comprising a second mass attached to the second end.

3. The device of claim 2, wherein each mass is spherical.

4. The device of claim 3, wherein a length of the filament is approximately ten inches.

5. The device of claim 3, wherein a length of the filament is approximately ten feet.

6. The device of claim 3, wherein a length of the filament is ranges from between approximately ten inches and approximately ten feet.

7. A device, comprising:
an elongated foil extending between a first end and a second end, wherein the foil is made of malleable material, and wherein the foil tapers from the second end to the first end; and
a first mass attached to the first end.

8. The device of claim 7, wherein a length of the foil is approximately 24 inches.

9. The device of claim 8, wherein a width of the second end is approximately three times a width of the first end.

10. A method for determining a counter drone approach of bringing down a drone in public without jam its controlling signal or using conventional weapons, comprising the steps of:
providing counter drone specifications selected from the group consisting of a type of drone to be brought down, a size of the propellers the type of drone, and an altitude and a distance of an interception;
determining the delivery mechanism based in part on the counter drone specifications;
making a counter drone device based in part on the counter drone specifications, the counter drone device comprising:
an elongated filament extending between a first end and a second end, wherein the filament provides at least 6 pounds per square inch of tensile strength; and
a first mass attached to the first end; and
targeting the interception of the propellers and/or a propeller shaft of the type of drone by using the delivery mechanism.

11. The method of claim 10, further comprising the step of determining a length of the filament and/or a weight of the mass based in part on the counter drone specifications.

12. The method of claim 10, wherein the delivery mechanism includes a paint ball firearm for low altitude targeting.
